(19) United States
(12) Patent Application Publication
(10) Pub. No.: US 2023/0350915 A1
(43) Pub. Date: Nov. 2, 2023

(54) APPLICATION BEHAVIOR BASED CUSTOMER DATA MIGRATION

(71) Applicant: Salesforce, Inc., San Francisco, CA (US)

(72) Inventor: Jyoti Ranjan, Hyderabad (IN)

(21) Appl. No.: 17/660,963

(22) Filed: Apr. 27, 2022

(51) Int. Cl. G06F 16/21; G06F 16/27

(52) U.S. Cl. CPC G06F 16/27; G06F 16/214

(57) ABSTRACT

Methods, apparatuses, and computer-program products are disclosed. The method may include receiving computing metadata associated with management of the data at the source data storage environment. The method may include computing a plurality of behavior parameters for the source data storage environment based on the computing metadata. The method may include determining one or more sub-configurations of a data migration plan based on an application of one or more machine learning models to the plurality of behavior parameters for the source data storage environment. The method may include generating the data migration plan based on a combination of the one or more sub-configurations. The method may include performing a data replication process to replicate the data from the source data storage environment to the target data storage environment based at least in part on the data migration plan.

### FIELD OF TECHNOLOGY

The present disclosure relates generally to database systems and data processing, and more specifically to customer data migration.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may migrate data between databases. However, methods for such data migration may be deficient.

### BRIEF DESCRIPTION OF THE DRAWINGS

FIG. 1 illustrates an example of configuring a migration of data from a source data storage environment to a target data storage environment system that supports application behavior based customer data migration in accordance with aspects of the present disclosure.

FIG. 2 illustrates an example of a system that supports application behavior based customer data migration in accordance with aspects of the present disclosure.

FIG. 3 illustrates an example of a system that supports application behavior based customer data migration in accordance with aspects of the present disclosure.

FIG. 4 illustrates an example of a process flow that supports application behavior based customer data migration in accordance with aspects of the present disclosure.

FIG. 5 shows a block diagram of an apparatus that supports application behavior based customer data migration in accordance with aspects of the present disclosure.

FIG. 6 shows a block diagram of a data replication manager that supports application behavior based customer data migration in accordance with aspects of the present disclosure.

FIG. 7 shows a diagram of a system including a device that supports application behavior based customer data migration in accordance with aspects of the present disclosure.

FIGS. 8 through 11 show flowcharts illustrating methods that support application behavior based customer data migration in accordance with aspects of the present disclosure.

### DETAILED DESCRIPTION

Users may create and manage a client environment that may include custom data, fields, objects, workflows, and other information specific to a client or organization. Information about such client environments may be analyzed, such as usage information, size, seasonality, data types, data patterns, and other information. In some cases, a client environment may be migrated from one infrastructure to another for various reasons. For example, the client environment may be migrated from one database architecture type to a different database architecture type, or from a local data storage environment to a public cloud storage environment, or any other combination of different storage environments. However, current replication or migration approaches utilize static configurations (e.g., involving predefined partitions and maps) for carrying out the migration process. Such approaches may over-consume resources, create static partitions that are not tailored to a particular environment or data, and ignore dynamics of data patterns present in the client environment.

Portions of the subject matter described herein describe the use of machine learning to dynamically determine a migration configuration, including the quantity of partitions that are to be used in connection with a migration strategy, a schedule, an estimated duration for performing the migration, a structure of one or more partitions (e.g., in terms of tables), infrastructure associated with a partition, or other parameters associated with the migration. The system may generate replication topologies that are used to create replication infrastructure, considering input from a replication administrator. The historical information associated with the client environment is used to determine behavior parameters that describe how elements of the client environment were used (e.g., input/output operations per second (IOPS), throughput, input/output (IO) size, latency, other parameters). The characteristics of the client environment, the behavior parameters, or both, are used to determine (e.g., using one or more machine learning approaches) one or more sub-configurations or sub-recommendations (e.g., for partition size, partition contents, infrastructure for hosting or running the client environment, seasonality considerations, other recommendations) that are combined to form a migration plan or migration configuration that may be used for performing the migration of the client environment.

In some examples, a partition analyzer may be used to analyze data spread across various data structures (e.g., tables). Such a partition analyzer may analyze input-output (IO) patterns across the different tables or data structures and may produce results regarding the partitioning of the data based on the analyzed patterns. In some examples, an infrastructure analyzer may be used to analyze loads on one or more systems (e.g., from a resource utilization perspective). Such an infrastructure analyzer may produce results regarding predicted resource usage (e.g., average usage, peak usage, or other usage metrics or measurements). In some examples, a load analyzer may be used to analyze the distribution of loads on one or more systems. Such a load analyzer may produce results regarding one or more time periods of varying load on the one or more systems, a forecasted schedule for replication or migration, or both.

Aspects of the disclosure are initially described in the context of an environment supporting an on-demand database service. Aspects of the disclosure are then described in the context of systems and a process flow. Aspects of the disclosure are further illustrated by and described with reference to apparatus diagrams, system diagrams, and flowcharts that relate to application behavior based customer data migration.

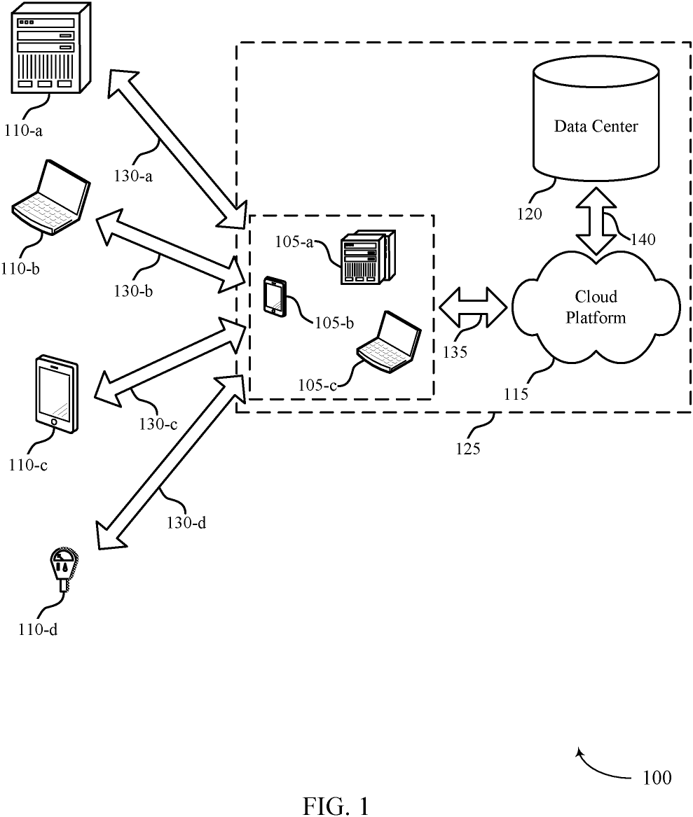

FIG. 1 illustrates an example of a system 100 for cloud computing that supports application behavior based customer data migration in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to-client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

A cloud client 105 may communicate with the cloud platform 115 to perform a data migration operation (e.g., migrating a client environment between multiple databases in the data center 120). The cloud client 105 may communicate with one or more elements of the cloud platform 115, such as a migration recommendation engine or one or more components thereof, to perform the migration operation. The migration recommendation engine may (e.g., through the use of machine learning techniques) analyze one or more sets of data associated with a client environment to generate a data migration plan based on one or more behavior parameters computed based on the data associated with the client environment. One or more aspects of the data migration plan may be generated by applying one or more machine learning models to one or more behavior parameters extracted or determined from the data. The data migration plan may then be carried out by one or more elements of the cloud platform 115 to migrate the data (e.g., a client environment).

In some approaches to data migration, one or more instances of services or software artifacts may perform data migration operations. In some such approaches, such services may divide the data to be migrated (e.g., a client environment) into a set of partitions. The services may then copy the various partitions to the destination. In such approaches, the services may utilize a static, pre-defined partition and map for replicating the data that may include little to no consideration of characteristics of the data to be migrated (e.g., data patterns). Further, as the data (e.g., from one or more different client environments) may include various use cases, data patterns, data structures, or other characteristics that may differ between sets of data, existing approaches fail to take such information into account, and only employ a static understanding of and rigid approach to data migration. Such limitations may result in poor utilization of resources for performing the data migration (e.g., wasted resources), poor partitioning of datasets (e.g., over-partitioning, under-partitioning, incorrect partitioning, or any combination thereof), loss of data (e.g., due to a lack of understanding or consideration of the data to be migrated), other consequences, or any combination thereof.

The subject matter described herein describes approaches to data migration (e.g., through the generation of a data migration plan) that reduces or eliminates the limitations of other approaches. Instead of relying on static, data-agnostic migration approaches, the subject matter described herein applies machine learning models to behavior parameters (e.g., historical data, metrics, measurements, or other information) associated with the particular data to be migrated (e.g., data associated with a client environment). By analyzing such data, the subject matter described herein may generate the behavior parameters and use the behavior parameters to generate one or more sub-configurations (e.g., data objects describing components or operations) of a data migration plan for migrating the data. Such sub-configurations may describe various aspects of the data migration plan, including partitioning schemes, load distributions, forecasting of datasets, forecasted resource usage (e.g., average, peak, etc.), time windows for performing the migration, a schedule for performing the migration, other aspects of a data migration plan, or any combination thereof. The sub-configurations may be generated by one or more components or sub-systems that may analyze the behavior parameters and may apply one or more machine learning models to the behavior parameters. In this way, a data migration plan data object or artifact may be generated based on an application of machine learning models to data objects that describe characteristics of the data (e.g., the client environment) to be migrated, thereby improving the operation of the replication system (e.g., by reducing resource consumption, increasing scalability of data structures that are being migrated, improving load distribution across resources, reducing data loss due to improper partitioning, increasing speed of replication processes, or other improvements to data migration technology).

A user (e.g., operating a client device 105) may transmit a request for data migration, such as data migration of a client environment with which the client interacts. The cloud platform 115 may retrieve historical information associated with the client environment that may describe operations, metrics, measurements, data flow, scheduling, patterns, or other information associated with the client environment. The cloud platform 115 may generate behavior parameters based on the historical information and may employ one or more analyzers to analyze the behavior parameters through application of machine learning models to the behavior parameters. Such analyzers may include a partition analyzer, an infrastructure analyzer, a load analyzer, one or more other analyzers, or any combination thereof. Such analyzers may also generate or output one or more sub-configurations of a data migration plan based on the application of the machine learning models. A migration strategy manager may incorporate, combine, integrate, or generate a data migration plan artifact or data object that may describe operations, orders, schedules, information, or any combination thereof for migrating the client environment to a data storage destination. The cloud platform 115 may then use the data migration plan or artifact to perform the data migration in accordance with the sub-configurations or other aspects of the data migration plan. In this way, data migration of a client environment may be performed with improved partitioning, resource utilization, load distribution, migration scheduling, or any combination thereof.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

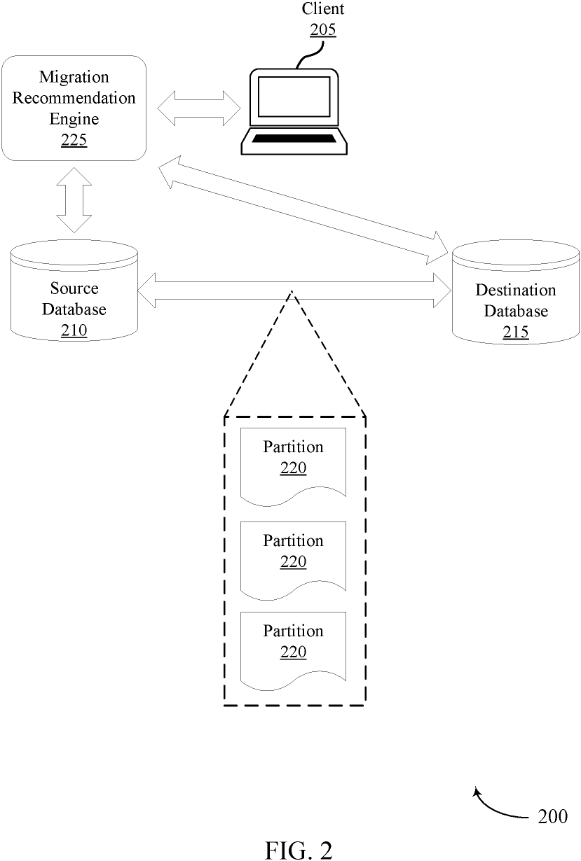

FIG. 2 illustrates an example of a system 200 that supports application behavior based customer data migration in accordance with aspects of the present disclosure. The system 200 may include a client 205, a source database 210, a destination database 215, and a migration recommendation engine 225. Such elements may be associated with or form part of a cloud computing system, application server, a multi-tenant system, or other implementations.

In some cloud computing systems (e.g., a multi-tenant system), users may interact with data storage and data processing elements via a client environment. A client environment may be a logical concept for data storage, data processing, or both, that may provide the user with a structure for interacting with data storage, data processing, or both. Such client environments may be internal to a cloud computing system, external to a cloud computing system, or mixed. In some examples, such client environments may be tailored for applications or use cases as a client requests. Such client environments may vary greatly in size and scale (e.g., 50 GB, 1 TB, 100 TB, 200 TB, petabyte-scale environments, or other sizes). Depending on the use case or purpose, a client environment may encounter more interaction during some time periods and less interaction during other time periods. For example, a client environment associated with banking may receive increased interaction during weekday business hours. Other client environments may receive more interaction during the weekend and less interaction during weekdays, such as video streaming services. Yet other client environments may receive more interactions during some portions of the year, such as client environments for a company that may offer promotions or discounts during a holiday season. Some client environments may also store or process various data types (e.g., VARCHAR2, Integer, Timestamp, or other data types) in various ways.

In some examples, client environments may process or store data in various ways, and such data usage may be described in terms of data patterns. For example, some client environments may encounter relatively constant levels of input-output operations per second (IOPS), whereas other client environments may have more “bursty” IOPS levels with more fluctuation. Some client environments may involve high levels of IOPS but may not prioritize data throughput levels.

Latency patterns may also be observed. For example, some client environments may involve scattered IO sizes (e.g., large amounts of IO and small amounts of IO) whereas other client environments may involve relatively regular sizes of IO with small deviations.

Frequency of database events may also be observed. For example, some client environment may involve a scattered or widely-varied number of database events in a given period of time, whereas other client environments may involve a regular flow of database events with small levels of deviation. Yet other client environments may involve low average numbers of database events with short periods of time with high levels of database events.

In the course of using such client environments, a user may desire to migrate a client environment to another database type, database location, database host, or other aspects of operation of the client environment. For example, a customer may wish to host data in a particular host or geographic location close to the customer’s location (e.g., in a particular country). Members of a team may wish to create clones of customer data or migrate data from one database type, format, or vendor to another database type, format, or vendor (e.g., to verify the correctness of the data). A testing team may wish to copy data to compute performance numbers historically archived in a system.

In some approaches to data migration, services or software artifacts may be used to replicate data, such as a client environment. Such services or artifacts may include the use of an interceptor and a replicator. An interceptor may aid in reading data from a source (e.g., either during a static copy (initial copy) or a change data capture (CDC) mode). An interceptor may provide a set of data to a replicator for a given partition from a given point in time. A replicator may pull data from an interceptor and may write data to a replication destination. A replicator may, during a write process, resolve conflicts arising because of related record datasets spread across different partitions.

However, such approaches may employ a pre-defined or rigid partition and mapping created between interceptors and replicators. For example, a cardinality relationship between interceptors and replicators may lack knowledge or consideration of the client environment and its characteristics (e.g., data patterns), and may impose a rigid replication scheme regardless of such characteristics. In such approaches, and as one example, a client environment of 50 GB may be treated the same as a client environment of 5 PB (e.g., with the same number of interceptors, partitions, and replicators). In addition, human-based approaches for reviewing characteristics of client environments with varying use cases and deployment architectures for migration or other operations is extremely cumbersome and complicated.

As can be seen, the inability of current approaches to consider characteristics of data (e.g., client environments) and dynamically adjust migration procedures accordingly results in various technical problems. For example, such approaches may involve poor utilization of available resources. In migration of small client environments, for example, strict creation of a number of partitions, interceptors, and replicators may involve excessive resources. This may lead to consuming excessive infrastructure and over-allocation of resources that are not required, resulting in problems from a cost perspective, especially in external environments or hosts that charge based on use (e.g., instead of using an internal infrastructure).

Such approaches may also involve non-optimal partitioning of client environment datasets. For example, a fixed number of partitions based on a static understanding of client environments is not optimal and scalable. For example, large client environments (e.g., involving a size of multiple PBs), a greater number of partitions (e.g., hundreds or more) may be more effective, whereas a lesser number of partitions (e.g., 20) may be effective for smaller client environments (e.g., hundreds of TBs).

Such approaches may also involve loss of specifics of the static partitions. For example, creating a partition with given a set of tables based on manual understanding may be analogous to taking a paper sheet and dividing it into 4 pieces (not necessarily all even) and allocating some section of a document to be written on such a piece. Such approaches may suffer from inefficiency, as they may not understand or take into account the dynamism of a data pattern of tables of the client environment.

As such, the subject matter described herein provides for approaches for migrating data (e.g., client environments) that reduce or eliminate the deficiencies of other approaches as described herein, and may leverage the historical data stored by a cloud computing system or other implementation that deals with data storage and processing related to client environments or other data.

For example, the client 205 may communicate with the migration recommendation engine 225 to perform a migration of data (e.g., a client environment) from the source database 210 to the destination database 215. The migration recommendation engine 225 may retrieve metadata associated with the client environment (e.g., from one or more sources, such as the source database 210 or other storage). This metadata may be used to compute one or more behavior parameters that may include data (e.g., characteristics of the client environment or how the client environment was used in the past) associated with the client environment. Using these behavior parameters, the migration recommendation engine 225 may generate or determine one or more sub-configurations of a data migration plan, data migration configuration, or data migration data object by applying one or more machine learning models to the behavior parameters. The migration recommendation engine 225 may then generate the data migration plan, data migration configuration, or data migration data object, which may include, designate, or define a number of partitions 220, the data that is to be included in the partitions 220, infrastructure to be used for the partitions 220, a migration schedule for migrating various portions of the data, estimation or prediction of a migration time (e.g., based on size, schedule, IO pattern, or any combination thereof), or any combination thereof. The actual migration of the client environment or data may then be performed in accordance with the data migration plan, data migration configuration, or data migration data object. In this way, the client environment or data may be migrated while taking into account the historical use and characteristics of the client environment and avoiding the deficiencies of previous static approaches.

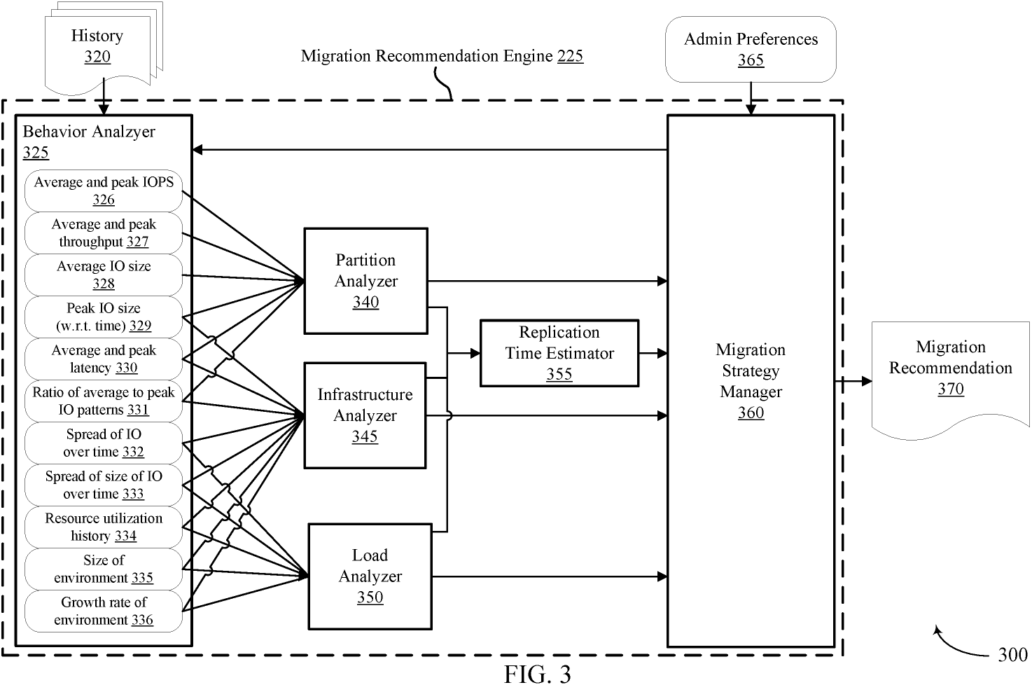

FIG. 3 illustrates an example of a system 300 that supports application behavior based customer data migration in accordance with aspects of the present disclosure. The system 300 may include the migration recommendation engine 225, which may include the behavior analyzer 325, the partition analyzer 340, the infrastructure analyzer 345, the load analyzer 350, the replication time estimator 355, and the migration strategy manager 360. The migration recommendation engine 225 may use the history 320, the admin preferences 365, or both, to generate the migration recommendation 370, which may be an example of the data migration plan, data migration artifact, data migration data object, or other similar elements described herein.

The migration recommendation engine 225 may orchestrate some or all of the operations described herein. For example, the migration recommendation engine 225 may orchestrate or coordinate with sub-systems of the migration recommendation engine 225 and external systems to carry out an overall objective of generating a migration plan containing various aspects of migrations (e.g., the best time for migration, a number of partitions, infrastructure for performing the data migrations, etc.). The migration recommendation engine 225 may leverage one or more sub-systems as described herein. Though some descriptions of operations or procedures may be described in an order, the migration strategy manager 360 may orchestrate, coordinate, or perform tasks or operations in various orders or in parallel.

The migration recommendation engine 225 may include the behavior analyzer 325. The behavior analyzer 325 may retrieve the history 320 from one or more data storage locations (e.g., the same data storage location that stores the client environment that may be migrated or another data storage location). The history 320 may include one or more sets of data that may include information such as IOPS, throughput, distribution of load across time, average I/O size, other information or metrics, or any combination thereof captured over a period of time in relation to the data or client environment that is to be migrated. Such data may be stored in one or more data storage locations either co-located with the client environment or stored separately.

The behavior analyzer 325 may produce relevant sets of data (e.g., behavior parameters) that may be used by various sub-components or sub-elements of the migration recommendation engine 225 for generating the migration recommendation 370. For example, the behavior analyzer 325 may perform one or more operations or procedures, including reading one or more historical datasets associated with the client environment from different sources, grouping similar and related datasets or behavior parameters, filtering out anomalies in the behavior parameters, or any combination thereof. For example, the behavior analyzer 325 may produce, organize, group, or generate behavior parameters such as average and peak IOPS 326, average and peak throughput 327, average IO size 328, peak IO size (w.r.t. time) 329, average and peak latency 330, ratio of average to peak IO patterns 331, spread of IO over time 332, spread of size of IO over time 333, resource utilization history 334, size of environment 335, growth rate of environment 336, or any combination thereof.

The partition analyzer 340 may read one or more data sets, behavior parameters, or both to comprehend or account for overall distributions of data (e.g., across different partitions, tables, data objects, or other elements), and may do so by applying one or more machine learning models to one or more datasets. For example, the partition analyzer 340 may analyze which divisions of data may be associated with various statistics, metrics, or measurements, such as the most IO, least IO, distribution of the size of IO across, time, load across time, a set of data divisions that were more or less involved in completing one customer request, a set of data divisions that are getting accessed mutually exclusively, other measurements or metrics, or any combination thereof. For example, as depicted, the partition analyzer 340 may process the average and peak IOPS 326, average and peak throughput 327, average IO size 328, peak IO size (w.r.t. time) 329, average and peak latency 330, ratio of average to peak IO patterns 331, or any combination thereof. Based on the application of the machine learning models, the partition analyzer 340 may generate one or more datasets, recommendations, configurations, sub-configurations, or information for the migration of the client environment that may include one or more partitions, composition of the one or more partitions (e.g., in terms of tables or other data organization), distribution of load on each partition, forecasted datasets to be generated for a given period for a given partition, or any combination thereof.

The infrastructure analyzer 345 may read one or more data sets, behavior parameters, or both to comprehend or account for loads on one or more systems from a resource utilization perspective (e.g., CPU, RAM, disk use, other resource usage, or any combination thereof) over one or more periods of time and may do so by applying one or more machine learning models to one or more datasets. For example, the one or more datasets may include data such as the peak IO size (w.r.t. time) 329, average and peak latency 330, ratio of average to peak IO patterns 331, spread of IO over time 332, spread of size of IO over time 333, resource utilization history 334, size of environment 335, growth rate of environment 336, or any combination thereof. The load analyzer 350 may determine, calculate, or identify one or more patterns in the one or more datasets to determine one or more infrastructure elements that are to be used for the migration of the client environment.

Additionally, or alternatively, the load analyzer 350 may produce one or more datasets, recommendations, configurations, sub-configurations, or information for the migration of the client environment that may include an average resource usage over a period of time (e.g., for one or more systems or infrastructure elements for migrating the client environment or data), a peak resource usage (e.g., for a duration of time, optionally with varying frequency), or both.

The load analyzer 350 may read one or more data sets, behavior parameters, or both to comprehend or account for distribution of one or more loads on one or more systems and may do so by applying one or more machine learning models to one or more datasets. For example, the one or more datasets may include the spread of IO over time 332, spread of size of IO over time 333, resource utilization history 334, size of environment 335, growth rate of environment 336, or any combination thereof. The load analyzer 350 may, by applying the one or more machine learning models to determine or select one or more time windows for part or all of a migration process of a client environment or other data. For example, the load analyzer 350 may determine one or more time windows when a load on a client environment may be lower than, at, or above a threshold (e.g., an activity threshold or a threshold based on any of the spread of IO over time 332, spread of size of IO over time 333, resource utilization history 334, size of environment 335, growth rate of environment 336, or any combination thereof) so that one or more resources are available for performing one or more migration procedures or processes (e.g., without affecting overall performance of the client environment). The load analyzer 350 may produce one or more datasets, recommendations, configurations, sub-configurations, or information for the migration of the client environment that may include one or more sets of one or more time windows for performing one or more migration operations (e.g., where the load on the client environment may be above or below a threshold), one or more forecasted schedules for the migration (e.g., that may be performed while the client environment is “live” or available to users without affecting such availability to users (e.g., at or below a threshold level of impact on resources used by the client environment)).

The replication time estimator 355 may read input from one or more other elements of the migration recommendation engine 225, including the partition analyzer 340, the infrastructure analyzer 345, the load analyzer 350, the migration strategy manager 360, the behavior analyzer 325, or any combination thereof. The replication time estimator 355 may estimate (e.g., through the use of application of one or more machine learning models) one or more amounts of time for performing migration of the client environment (e.g., depending on one or more migration schedules, partitions, infrastructure, loads, or any combination thereof). For the example, the replication time estimator 355 may produce one or more datasets, recommendations, configurations, sub-configurations, or information for the migration of the client environment that may include one or more recommended time slots for replication (e.g., with the estimated time taken to complete replication for each partition). Such datasets, recommendations, configurations, sub-configurations, or information may include more than one proposal (e.g., so that a user may select one or more proposals, optionally based on other factors like the convenience of one or more migration windows, replication site reliability engineering availability, other factors, or any combination thereof).

The migration recommendation engine 225 may include an input system that may receive or retrieve one or more admin preferences 365. Such admin preferences 365 may include input from a user, an administrator, or both, that may alter behavior of one or more elements of the migration recommendation engine 225 (e.g., so that a practical recommendation of a migration strategy or migration recommendation 370 may be provided). For example, such admin preferences 365 may include information such as one or more preferred time slots for migration, performance data of one or more services used for migration or replication, one or more indications of data grouping (e.g., instructions to group certain sets of tables or data divisions in one or more partitions).

Once the migration recommendation 370 is generated, the migration recommendation engine 225 may transmit the migration recommendation 370 to a replication topology manager (RTM). The RTM may be used to create one or more instances of replication topology, which may be specific to migration of a given client environment or dataset, and may be influence or altered by the migration recommendation 370. The topology may be a cloud-native template that may be used to create replication infrastructure and schedule the replication as guided by the migration recommendation engine 225. Such templates may be specific to one or more cloud service providers. In some examples, the RTM may generates one or more sets of data to be consumed by a replication infrastructure as a service controller, which may include a replication infrastructure cloud template and a manifest to schedule client environment migrations (e.g., as per one or more recommendations) so that client environment migration may be performed at a point of time when it has a low user load.

In some examples, a replication infrastructure as a service controller (RIaaSC) may receive one or more artifacts or data objects (e.g., created by the migration recommendation engine 225, an RTM, or other element) and may perform one or more procedures or processes (e.g., as instructed or configure by an administrator, a configuration, or both). For example, the RIaaSC may create replication infrastructure by invoking one or more cloud APIs (e.g., that may be specific to a cloud services host or provider). Additionally, or alternatively, the RIaaSC may configure one or more replication services to be rescheduled. Such rescheduling may be performed to adjust resource utilization, load, or both of the overall system (e.g., so that user behavior does not get impacted significantly because of migration operations). Such rescheduling may be performed upon administrator request, if user operations are being performed on the client environment, or both. In some examples, if the migration processes are standalone (e.g., are not interfering with user operations), then such rescheduling may not be performed.

In this way, the approaches described herein offer various characteristics. The subject matter described herein may involve a scheme of machine-learning based dynamic creation client environment migration infrastructure. Approaches may include machine learning-based study of client environment history or data to derive various analytical data that may be helpful for the migration recommendation engine 225 in creating the migration recommendation 370, thereby offering a dynamic learning-based recommendation for migration strategy. The approaches described herein may include optimization of cost since infrastructure resources may be used more efficiently. In some examples, a “best fit” replication strategy approach for various client environments may be employed. In this way, the subject matter described herein may avoid the pitfalls of a “single hammer” for all jobs, which may in turn avoid over- or under-planning (or provisioning) of resources. The approaches described herein may support mass client environment or data migration use cases for internal or external customer, as well as for various types of environments. In addition, the migration recommendation engine 225 as described herein (as well as other approaches described herein) may be agnostic as to which particular cloud service or host may be used. As such, migration that is sensitive to variances and differences between client environments may be performed across difference cloud services or providers.

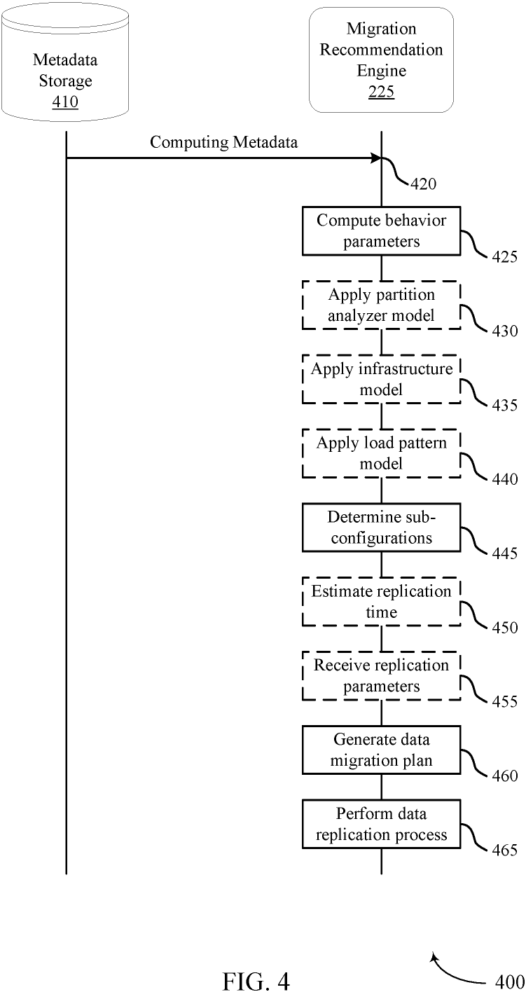

FIG. 4 illustrates an example of a process flow 400 that supports application behavior based customer data migration in accordance with aspects of the present disclosure. The process flow 400 may implement various aspects of the present disclosure described herein. The elements described in the process flow 400 may be examples of similarly-named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the migration recommendation engine 225 may receive computing metadata associated with management of the data at the source data storage environment.

At 425, the migration recommendation engine 225 may compute a plurality of behavior parameters for the source data storage environment based on the computing metadata.

At 430, the migration recommendation engine 225 may apply a partition analyzer machine learning model to one or more of the plurality of behavior parameters.

At 435, the migration recommendation engine 225 may apply an infrastructure recommendation machine learning model to one or more of the plurality of behavior parameters.

At 440, the migration recommendation engine 225 may apply a load pattern machine learning model to one or more of the plurality of behavior parameters.

At 445, the migration recommendation engine 225 may determine one or more sub-configurations of a data migration plan based on an application of one or more machine learning models to the plurality of behavior parameters for the source data storage environment.

In some examples, the migration recommendation engine 225 may generate a partitioning sub-configuration for partitioning the data based on the applying, the partitioning sub-configuration including one or more partitioning parameters. In some examples, the migration recommendation engine 225 may generate the partitioning sub-configuration based on an input operation performance metric, an output operation performance metric, a data throughput metric, a data input size metric, a data output size metric, a data write time metric, a latency metric, a data input pattern metric, a data output pattern metric, or any combination thereof. In some examples, the partitioning sub-configuration may include an indication of a partition, a tabular composition of the partition, an indication of a load distribution on the partition, one or more forecasted datasets associated with the partition, or any combination thereof.

In some examples, the migration recommendation engine 225 may generate an infrastructure sub-configuration for partitioning the data based on the applying, the infrastructure sub-configuration including one or more infrastructure parameters. In some examples, the migration recommendation engine 225 may generate the infrastructure sub-configuration based on a data write time metric, a latency metric, a data input pattern metric, a data output pattern metric, an input operation timing metric, an output operation timing metric, a data size timing metric, a resource utilization history metric, a data storage environment size metric, a data storage environment growth rate metric, or any combination thereof. In some examples, the infrastructure sub-configuration may include an indication of an average resource usage level for the data replication process, a peak resource usage level for the data replication process, or any combination thereof.

In some examples, the migration recommendation engine 225 may generate a load pattern sub-configuration for partitioning the data based on the applying, the load pattern sub-configuration including one or more load distribution parameters. In some examples, the migration recommendation engine 225 may generate the load pattern sub-configuration based on an input operation timing metric, an output operation timing metric, a data size timing metric, a data storage environment size metric, a data storage environment growth rate metric, or any combination thereof. In some examples, the load pattern sub-configuration may include one or more time windows associated with one or more load levels of the source data storage environment, a forecasted schedule for the data replication process, or any combination thereof.

At 450, the migration recommendation engine 225 may estimate an amount of time for performing the data replication process based on the one or more sub-configurations. In some examples, the migration recommendation engine 225 may generate one or more recommended time slots for the data replication process based on the estimating.

At 455, the migration recommendation engine 225 may receive one or more data replication parameters for performing the data replication process. In some examples, the one or more data replication parameters include a preferred time slot, data replication performance metadata, an indication of a data partitioning scheme, or any combination thereof.

At 460, the migration recommendation engine 225 may generate the data migration plan based on a combination of the one or more sub-configurations.

At 465, the migration recommendation engine 225 may perform a data replication process to replicate the data from the source data storage environment to the target data storage environment based on the data migration plan. In some examples, performing the data replication process may be based on the one or more data replication parameters.

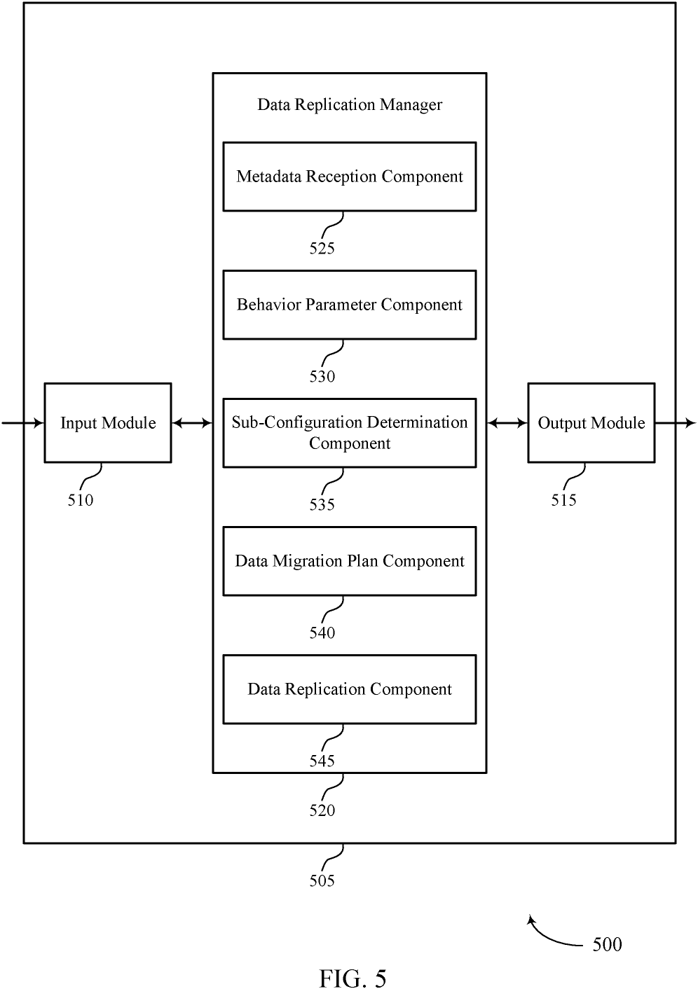

FIG. 5 shows a block diagram 500 of a device 505 that supports application behavior based customer data migration in accordance with aspects of the present disclosure. The device 505 may include an input module 510, an output module 515, and a data replication manager 520. The device 505 may also include a processor. Each of these components may be in communication with one another (e.g., via one or more buses).

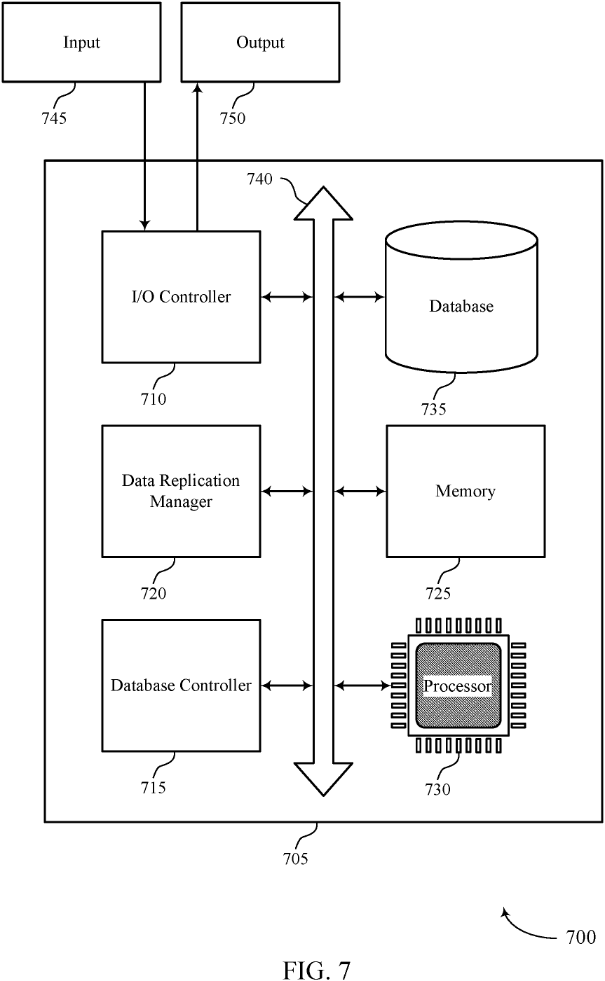

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the data replication manager 520 to support application behavior based customer data migration. In some cases, the input module 510 may be a component of an I/O controller 710 as described with reference to FIG. 7.

The output module 515 may manage output signals for the device 505. For example, the output module 515 may receive signals from other components of the device 505, such as the data replication manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the data replication manager 520 may include a metadata reception component 525, a behavior parameter component 530, a sub-configuration determination component 535, a data migration plan component 540, a data replication component 545, or any combination thereof. In some examples, the data replication manager 520, or various components thereof, may be configured to perform various operations (e.g., receiving, monitoring, transmitting) using or otherwise in cooperation with the input module 510, the output module 515, or both. For example, the data replication manager 520 may receive information from the input module 510, send information to the output module 515, or be integrated in combination with the input module 510, the output module 515, or both to receive information, transmit information, or perform various other operations as described herein.

The data replication manager 520 may support configuring a migration of data from a source data storage environment to a target data storage environment in accordance with examples as disclosed herein. The metadata reception component 525 may be configured as or otherwise support a means for receiving computing metadata associated with management of the data at the source data storage environment. The behavior parameter component 530 may be configured as or otherwise support a means for computing a set of multiple behavior parameters for the source data storage environment based on the computing metadata. The sub-configuration determination component 535 may be configured as or otherwise support a means for determining one or more sub-configurations of a data migration plan based on an application of one or more machine learning models to the set of multiple behavior parameters for the source data storage environment. The data migration plan component 540 may be configured as or otherwise support a means for generating the data migration plan based on a combination of the one or more sub-configurations. The data replication component 545 may be configured as or otherwise support a means for performing a data replication process to replicate the data from the source data storage environment to the target data storage environment based on the data migration plan.

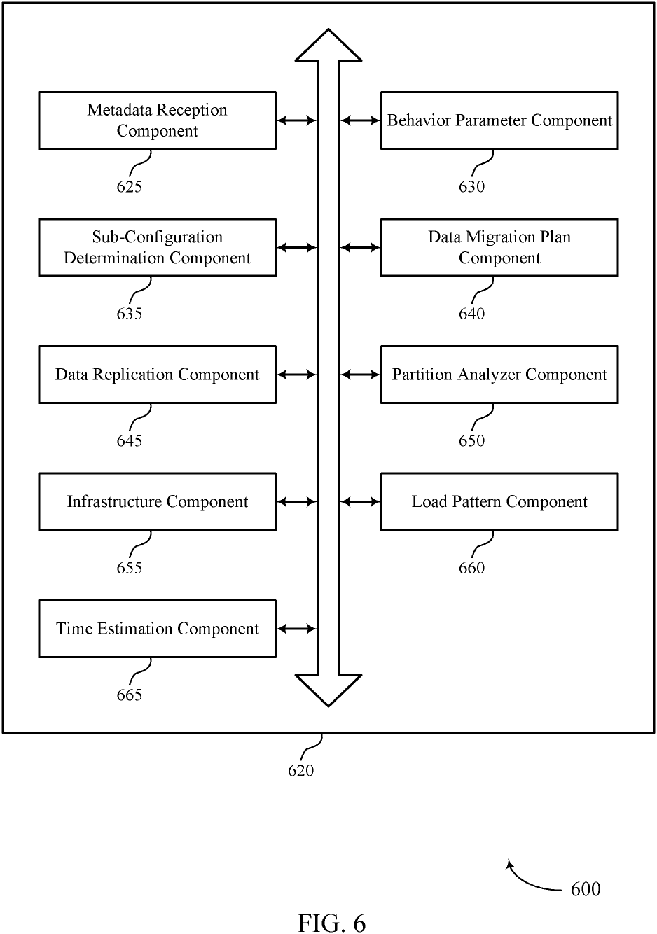

FIG. 6 shows a block diagram 600 of a data replication manager 620 that supports application behavior based customer data migration in accordance with aspects of the present disclosure. The data replication manager 620 may be an example of aspects of a data replication manager or a data replication manager 520, or both, as described herein. The data replication manager 620, or various components thereof, may be an example of means for performing various aspects of application behavior based customer data migration as described herein. For example, the data replication manager 620 may include a metadata reception component 625, a behavior parameter component 630, a sub-configuration determination component 635, a data migration plan component 640, a data replication component 645, a partition analyzer component 650, an infrastructure component 655, a load pattern component 660, a time estimation component 665, or any combination thereof. Each of these components may communicate, directly or indirectly, with one another (e.g., via one or more buses).

The data replication manager 620 may support configuring a migration of data from a source data storage environment to a target data storage environment in accordance with examples as disclosed herein. The metadata reception component 625 may be configured as or otherwise support a means for receiving computing metadata associated with management of the data at the source data storage environment. The behavior parameter component 630 may be configured as or otherwise support a means for computing a set of multiple behavior parameters for the source data storage environment based on the computing metadata. The sub-configuration determination component 635 may be configured as or otherwise support a means for determining one or more sub-configurations of a data migration plan based on an application of one or more machine learning models to the set of multiple behavior parameters for the source data storage environment. The data migration plan component 640 may be configured as or otherwise support a means for generating the data migration plan based on a combination of the one or more sub-configurations. The data replication component 645 may be configured as or otherwise support a means for performing a data replication process to replicate the data from the source data storage environment to the target data storage environment based on the data migration plan.

In some examples, the partition analyzer component 650 may be configured as or otherwise support a means for applying a partition analyzer machine learning model to one or more of the set of multiple behavior parameters. In some examples, the sub-configuration determination component 635 may be configured as or otherwise support a means for generating a partitioning sub-configuration for partitioning the data based on the applying, the partitioning sub-configuration including one or more partitioning parameters.

In some examples, the sub-configuration determination component 635 may be configured as or otherwise support a means for generating the partitioning sub-configuration based on an input operation performance metric, an output operation performance metric, a data throughput metric, a data input size metric, a data output size metric, a data write time metric, a latency metric, a data input pattern metric, a data output pattern metric, or any combination thereof.

In some examples, the partitioning sub-configuration includes an indication of a partition, a tabular composition of the partition, an indication of a load distribution on the partition, one or more forecasted datasets associated with the partition, or any combination thereof.

In some examples, the infrastructure component 655 may be configured as or otherwise support a means for applying an infrastructure recommendation machine learning model to one or more of the set of multiple behavior parameters. In some examples, the sub-configuration determination component 635 may be configured as or otherwise support a means for generating an infrastructure sub-configuration for partitioning the data based on the applying, the infrastructure sub-configuration including one or more infrastructure parameters.

In some examples, the sub-configuration determination component 635 may be configured as or otherwise support a means for generating the infrastructure sub-configuration based on a data write time metric, a latency metric, a data input pattern metric, a data output pattern metric, an input operation timing metric, an output operation timing metric, a data size timing metric, a resource utilization history metric, a data storage environment size metric, a data storage environment growth rate metric, or any combination thereof.

In some examples, the infrastructure sub-configuration includes an indication of an average resource usage level for the data replication process, a peak resource usage level for the data replication process, or any combination thereof.

In some examples, the load pattern component 660 may be configured as or otherwise support a means for applying a load pattern machine learning model to one or more of the set of multiple behavior parameters. In some examples, the sub-configuration determination component 635 may be configured as or otherwise support a means for generating a load pattern sub-configuration for partitioning the data based on the applying, the load pattern sub-configuration including one or more load distribution parameters.

In some examples, the sub-configuration determination component 635 may be configured as or otherwise support a means for generating the load pattern sub-configuration based on an input operation timing metric, an output operation timing metric, a data size timing metric, a data storage environment size metric, a data storage environment growth rate metric, or any combination thereof.

In some examples, the load pattern sub-configuration includes one or more time windows associated with one or more load levels of the source data storage environment, a forecasted schedule for the data replication process, or any combination thereof.

In some examples, the time estimation component 665 may be configured as or otherwise support a means for estimating an amount of time for performing the data replication process based on the one or more sub-configurations. In some examples, the time estimation component 665 may be configured as or otherwise support a means for generating one or more recommended time slots for the data replication process based on the estimating.

In some examples, the data migration plan component 640 may be configured as or otherwise support a means for receiving one or more data replication parameters for performing the data replication process. In some examples, the data replication component 645 may be configured as or otherwise support a means for performing the data replication process based on the one or more data replication parameters.

In some examples, the one or more data replication parameters include a preferred time slot, data replication performance metadata, an indication of a data partitioning scheme, or any combination thereof.

FIG. 7 shows a diagram of a system 700 including a device 705 that supports application behavior based customer data migration in accordance with aspects of the present disclosure. The device 705 may be an example of or include the components of a device 505 as described herein. The device 705 may include components for bi-directional data communications including components for transmitting and receiving communications, such as a data replication manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting application behavior based customer data migration).

The data replication manager 720 may support configuring a migration of data from a source data storage environment to a target data storage environment in accordance with examples as disclosed herein. For example, the data replication manager 720 may be configured as or otherwise support a means for receiving computing metadata associated with management of the data at the source data storage environment. The data replication manager 720 may be configured as or otherwise support a means for computing a set of multiple behavior parameters for the source data storage environment based on the computing metadata. The data replication manager 720 may be configured as or otherwise support a means for determining one or more sub-configurations of a data migration plan based on an application of one or more machine learning models to the set of multiple behavior parameters for the source data storage environment. The data replication manager 720 may be configured as or otherwise support a means for generating the data migration plan based on a combination of the one or more sub-configurations. The data replication manager 720 may be configured as or otherwise support a means for performing a data replication process to replicate the data from the source data storage environment to the target data storage environment based on the data migration plan.

By including or configuring the data replication manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

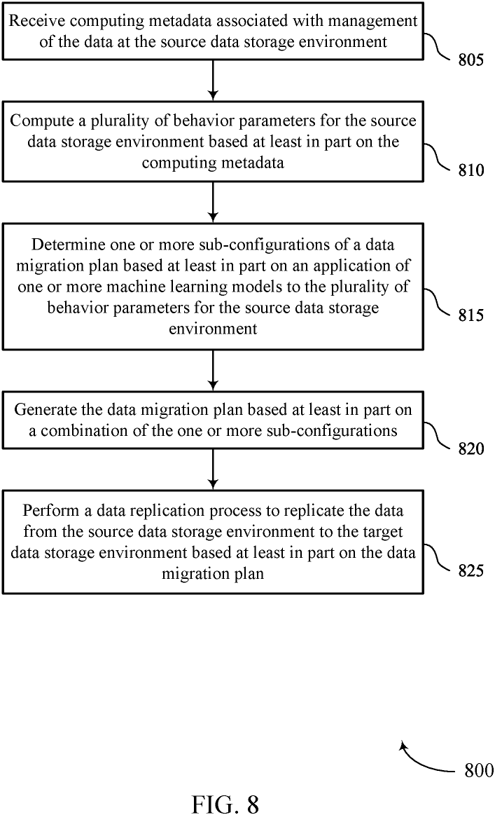

FIG. 8 shows a flowchart illustrating a method 800 that supports application behavior based customer data migration in accordance with aspects of the present disclosure. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include receiving computing metadata associated with management of the data at the source data storage environment. The operations of 805 may be performed in accordance with examples as disclosed herein. In some examples, aspects of the operations of 805 may be performed by a metadata reception component 625 as described with reference to FIG. 6.

At 810, the method may include computing a set of multiple behavior parameters for the source data storage environment based on the computing metadata. The operations of 810 may be performed in accordance with examples as disclosed herein. In some examples, aspects of the operations of 810 may be performed by a behavior parameter component 630 as described with reference to FIG. 6.

At 815, the method may include determining one or more sub-configurations of a data migration plan based on an application of one or more machine learning models to the set of multiple behavior parameters for the source data storage environment. The operations of 815 may be performed in accordance with examples as disclosed herein. In some examples, aspects of the operations of 815 may be performed by a sub-configuration determination component 635 as described with reference to FIG. 6.

At 820, the method may include generating the data migration plan based on a combination of the one or more sub-configurations. The operations of 820 may be performed in accordance with examples as disclosed herein. In some examples, aspects of the operations of 820 may be performed by a data migration plan component 640 as described with reference to FIG. 6.

At 825, the method may include performing a data replication process to replicate the data from the source data storage environment to the target data storage environment based on the data migration plan. The operations of 825 may be performed in accordance with examples as disclosed herein. In some examples, aspects of the operations of 825 may be performed by a data replication component 645 as described with reference to FIG. 6.

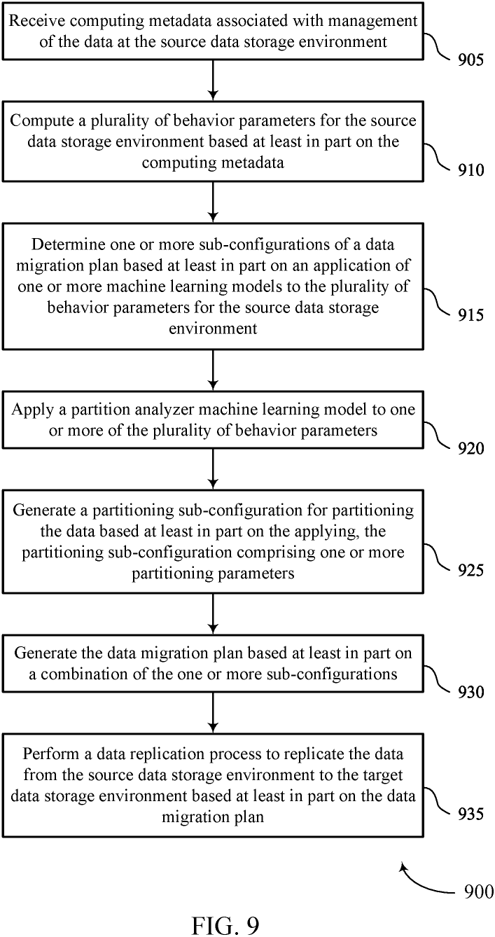

FIG. 9 shows a flowchart illustrating a method 900 that supports application behavior based customer data migration in accordance with aspects of the present disclosure. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 905, the method may include receiving computing metadata associated with management of the data at the source data storage environment. The operations of 905 may be performed in accordance with examples as disclosed herein. In some examples, aspects of the operations of 905 may be performed by a metadata reception component 625 as described with reference to FIG. 6.

At 910, the method may include computing a set of multiple behavior parameters for the source data storage environment based on the computing metadata. The operations of 910 may be performed in accordance with examples as disclosed herein. In some examples, aspects of the operations of 910 may be performed by a behavior parameter component 630 as described with reference to FIG. 6.

At 915, the method may include determining one or more sub-configurations of a data migration plan based on an application of one or more machine learning models to the set of multiple behavior parameters for the source data storage environment. The operations of 915 may be performed in accordance with examples as disclosed herein. In some examples, aspects of the operations of 915 may be performed by a sub-configuration determination component 635 as described with reference to FIG. 6.

At 920, the method may include applying a partition analyzer machine learning model to one or more of the set of multiple behavior parameters. The operations of 920 may be performed in accordance with examples as disclosed herein. In some examples, aspects of the operations of 920 may be performed by a partition analyzer component 650 as described with reference to FIG. 6.

At 925, the method may include generating a partitioning sub-configuration for partitioning the data based on the applying, the partitioning sub-configuration including one or more partitioning parameters. The operations of 925 may be performed in accordance with examples as disclosed herein. In some examples, aspects of the operations of 925 may be performed by a sub-configuration determination component 635 as described with reference to FIG. 6.

At 930, the method may include generating the data migration plan based on a combination of the one or more sub-configurations. The operations of 930 may be performed in accordance with examples as disclosed herein. In some examples, aspects of the operations of 930 may be performed by a data migration plan component 640 as described with reference to FIG. 6.

At 935, the method may include performing a data replication process to replicate the data from the source data storage environment to the target data storage environment based on the data migration plan. The operations of 935 may be performed in accordance with examples as disclosed herein. In some examples, aspects of the operations of 935 may be performed by a data replication component 645 as described with reference to FIG. 6.

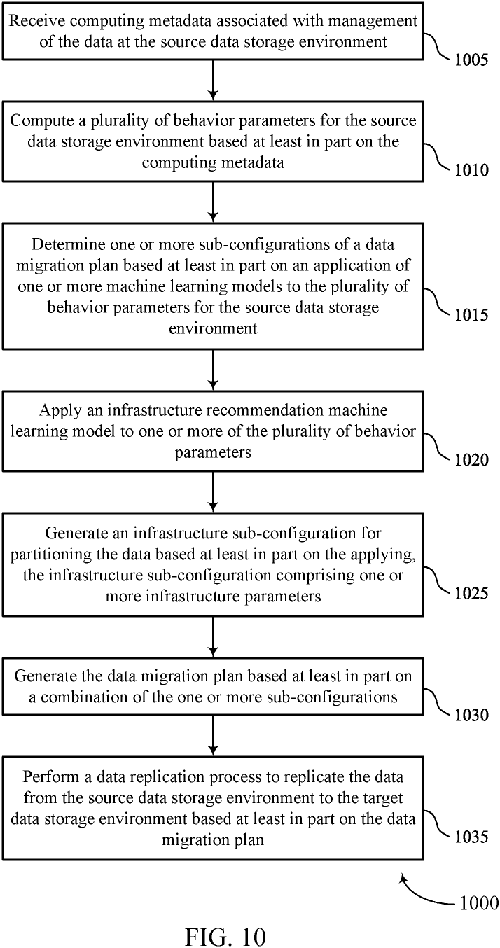

FIG. 10 shows a flowchart illustrating a method 1000 that supports application behavior based customer data migration in accordance with aspects of the present disclosure. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 1005, the method may include receiving computing metadata associated with management of the data at the source data storage environment. The operations of 1005 may be performed in accordance with examples as disclosed herein. In some examples, aspects of the operations of 1005 may be performed by a metadata reception component 625 as described with reference to FIG. 6.

At 1010, the method may include computing a set of multiple behavior parameters for the source data storage environment based on the computing metadata. The operations of 1010 may be performed in accordance with examples as disclosed herein. In some examples, aspects of the operations of 1010 may be performed by a behavior parameter component 630 as described with reference to FIG. 6.

At 1015, the method may include determining one or more sub-configurations of a data migration plan based on an application of one or more machine learning models to the set of multiple behavior parameters for the source data storage environment. The operations of 1015 may be performed in accordance with examples as disclosed herein. In some examples, aspects of the operations of 1015 may be performed by a sub-configuration determination component 635 as described with reference to FIG. 6.

At 1020, the method may include applying an infrastructure recommendation machine learning model to one or more of the set of multiple behavior parameters. The operations of 1020 may be performed in accordance with examples as disclosed herein. In some examples, aspects of the operations of 1020 may be performed by an infrastructure component 655 as described with reference to FIG. 6.

At 1025, the method may include generating an infrastructure sub-configuration for partitioning the data based on the applying, the infrastructure sub-configuration including one or more infrastructure parameters. The operations of 1025 may be performed in accordance with examples as disclosed herein. In some examples, aspects of the operations of 1025 may be performed by a sub-configuration determination component 635 as described with reference to FIG. 6.

At 1030, the method may include generating the data migration plan based on a combination of the one or more sub-configurations. The operations of 1030 may be performed in accordance with examples as disclosed herein. In some examples, aspects of the operations of 1030 may be performed by a data migration plan component 640 as described with reference to FIG. 6.

At 1035, the method may include performing a data replication process to replicate the data from the source data storage environment to the target data storage environment based on the data migration plan. The operations of 1035 may be performed in accordance with examples as disclosed herein. In some examples, aspects of the operations of 1035 may be performed by a data replication component 645 as described with reference to FIG. 6.

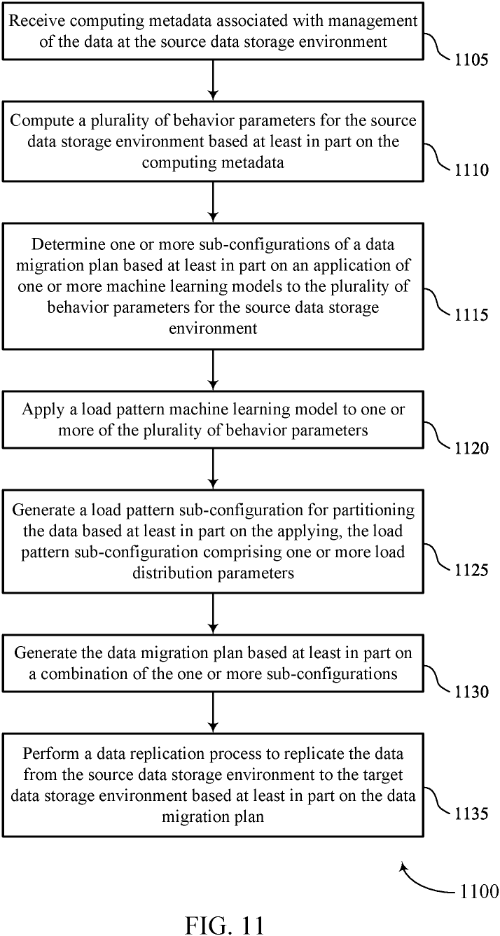

FIG. 11 shows a flowchart illustrating a method 1100 that supports application behavior based customer data migration in accordance with aspects of the present disclosure. The operations of the method 1100 may be implemented by an application server or its components as described herein. For example, the operations of the method 1100 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 1105, the method may include receiving computing metadata associated with management of the data at the source data storage environment. The operations of 1105 may be performed in accordance with examples as disclosed herein. In some examples, aspects of the operations of 1105 may be performed by a metadata reception component 625 as described with reference to FIG. 6.

At 1110, the method may include computing a set of multiple behavior parameters for the source data storage environment based on the computing metadata. The operations of 1110 may be performed in accordance with examples as disclosed herein. In some examples, aspects of the operations of 1110 may be performed by a behavior parameter component 630 as described with reference to FIG. 6.

At 1115, the method may include determining one or more sub-configurations of a data migration plan based on an application of one or more machine learning models to the set of multiple behavior parameters for the source data storage environment. The operations of 1115 may be performed in accordance with examples as disclosed herein. In some examples, aspects of the operations of 1115 may be performed by a sub-configuration determination component 635 as described with reference to FIG. 6.

At 1120, the method may include applying a load pattern machine learning model to one or more of the set of multiple behavior parameters. The operations of 1120 may be performed in accordance with examples as disclosed herein. In some examples, aspects of the operations of 1120 may be performed by a load pattern component 660 as described with reference to FIG. 6.

At 1125, the method may include generating a load pattern sub-configuration for partitioning the data based on the applying, the load pattern sub-configuration including one or more load distribution parameters. The operations of 1125 may be performed in accordance with examples as disclosed herein. In some examples, aspects of the operations of 1125 may be performed by a sub-configuration determination component 635 as described with reference to FIG. 6.

At 1130, the method may include generating the data migration plan based on a combination of the one or more sub-configurations. The operations of 1130 may be performed in accordance with examples as disclosed herein. In some examples, aspects of the operations of 1130 may be performed by a data migration plan component 640 as described with reference to FIG. 6.

At 1135, the method may include performing a data replication process to replicate the data from the source data storage environment to the target data storage environment based on the data migration plan. The operations of 1135 may be performed in accordance with examples as disclosed herein. In some examples, aspects of the operations of 1135 may be performed by a data replication component 645 as described with reference to FIG. 6.

A method for configuring a migration of data from a source data storage environment to a target data storage environment is described. The method may include receiving computing metadata associated with management of the data at the source data storage environment, computing a set of multiple behavior parameters for the source data storage environment based on the computing metadata, determining one or more sub-configurations of a data migration plan based on an application of one or more machine learning models to the set of multiple behavior parameters for the source data storage environment, generating the data migration plan based on a combination of the one or more sub-configurations, and performing a data replication process to replicate the data from the source data storage environment to the target data storage environment based on the data migration plan.

An apparatus for configuring a migration of data from a source data storage environment to a target data storage environment is described. The apparatus may include a processor, memory coupled with the processor, and instructions stored in the memory. The instructions may be executable by the processor to cause the apparatus to receive computing metadata associated with management of the data at the source data storage environment, compute a set of multiple behavior parameters for the source data storage environment based on the computing metadata, determine one or more sub-configurations of a data migration plan based on an application of one or more machine learning models to the set of multiple behavior parameters for the source data storage environment, generate the data migration plan based on a combination of the one or more sub-configurations, and perform a data replication process to replicate the data from the source data storage environment to the target data storage environment based on the data migration plan.

Another apparatus for configuring a migration of data from a source data storage environment to a target data storage environment is described. The apparatus may include means for receiving computing metadata associated with management of the data at the source data storage environment, means for computing a set of multiple behavior parameters for the source data storage environment based on the computing metadata, means for determining one or more sub-configurations of a data migration plan based on an application of one or more machine learning models to the set of multiple behavior parameters for the source data storage environment, means for generating the data migration plan based on a combination of the one or more sub-configurations, and means for performing a data replication process to replicate the data from the source data storage environment to the target data storage environment based on the data migration plan.

A non-transitory computer-readable medium storing code for configuring a migration of data from a source data storage environment to a target data storage environment is described. The code may include instructions executable by a processor to receive computing metadata associated with management of the data at the source data storage environment, compute a set of multiple behavior parameters for the source data storage environment based on the computing metadata, determine one or more sub-configurations of a data migration plan based on an application of one or more machine learning models to the set of multiple behavior parameters for the source data storage environment, generate the data migration plan based on a combination of the one or more sub-configurations, and perform a data replication process to replicate the data from the source data storage environment to the target data storage environment based on the data migration plan.

Some examples of the method, apparatuses, and non-transitory computer-readable medium described herein may further include operations, features, means, or instructions for applying a partition analyzer machine learning model to one or more of the set of multiple behavior parameters and generating a partitioning sub-configuration for partitioning the data based on the applying, the partitioning sub-configuration including one or more partitioning parameters.

Some examples of the method, apparatuses, and non-transitory computer-readable medium described herein may further include operations, features, means, or instructions for generating the partitioning sub-configuration based on an input operation performance metric, an output operation performance metric, a data throughput metric, a data input size metric, a data output size metric, a data write time metric, a latency metric, a data input pattern metric, a data output pattern metric, or any combination thereof.

In some examples of the method, apparatuses, and non-transitory computer-readable medium described herein, the partitioning sub-configuration includes an indication of a partition, a tabular composition of the partition, an indication of a load distribution on the partition, one or more forecasted datasets associated with the partition, or any combination thereof.

Some examples of the method, apparatuses, and non-transitory computer-readable medium described herein may further include operations, features, means, or instructions for applying an infrastructure recommendation machine learning model to one or more of the set of multiple behavior parameters and generating an infrastructure sub-configuration for partitioning the data based on the applying, the infrastructure sub-configuration including one or more infrastructure parameters.

Some examples of the method, apparatuses, and non-transitory computer-readable medium described herein may further include operations, features, means, or instructions for generating the infrastructure sub-configuration based on a data write time metric, a latency metric, a data input pattern metric, a data output pattern metric, an input operation timing metric, an output operation timing metric, a data size timing metric, a resource utilization history metric, a data storage environment size metric, a data storage environment growth rate metric, or any combination thereof.

In some examples of the method, apparatuses, and non-transitory computer-readable medium described herein, the infrastructure sub-configuration includes an indication of an average resource usage level for the data replication process, a peak resource usage level for the data replication process, or any combination thereof.

Some examples of the method, apparatuses, and non-transitory computer-readable medium described herein may further include operations, features, means, or instructions for applying a load pattern machine learning model to one or more of the set of multiple behavior parameters and generating a load pattern sub-configuration for partitioning the data based on the applying, the load pattern sub-configuration including one or more load distribution parameters.

Some examples of the method, apparatuses, and non-transitory computer-readable medium described herein may further include operations, features, means, or instructions for generating the load pattern sub-configuration based on an input operation timing metric, an output operation timing metric, a data size timing metric, a data storage environment size metric, a data storage environment growth rate metric, or any combination thereof.

In some examples of the method, apparatuses, and non-transitory computer-readable medium described herein, the load pattern sub-configuration includes one or more time windows associated with one or more load levels of the source data storage environment, a forecasted schedule for the data replication process, or any combination thereof.

Some examples of the method, apparatuses, and non-transitory computer-readable medium described herein may further include operations, features, means, or instructions for estimating an amount of time for performing the data replication process based on the one or more sub-configurations and generating one or more recommended time slots for the data replication process based on the estimating.

Some examples of the method, apparatuses, and non-transitory computer-readable medium described herein may further include operations, features, means, or instructions for receiving one or more data replication parameters for performing the data replication process and performing the data replication process based on the one or more data replication parameters.

In some examples of the method, apparatuses, and non-transitory computer-readable medium described herein, the one or more data replication parameters include a preferred time slot, data replication performance metadata, an indication of a data partitioning scheme, or any combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for configuring a migration of data from a source data storage environment to a target data storage environment, comprising:
receiving computing metadata associated with management of the data at the source data storage environment;
computing a plurality of behavior parameters for the source data storage environment based at least in part on the computing metadata;
determining one or more sub-configurations of a data migration plan based at least in part on an application of one or more machine learning models to the plurality of behavior parameters for the source data storage environment;
generating the data migration plan based at least in part on a combination of the one or more sub-configurations; and
performing a data replication process to replicate the data from the source data storage environment to the target data storage environment based at least in part on the data migration plan.

2. The method of claim 1, further comprising:
applying a partition analyzer machine learning model to one or more of the plurality of behavior parameters; and
generating a partitioning sub-configuration for partitioning the data based at least in part on the applying, the partitioning sub-configuration comprising one or more partitioning parameters.

3. The method of claim 2, further comprising:
generating the partitioning sub-configuration based at least in part on an input operation performance metric, an output operation performance metric, a data throughput metric, a data input size metric, a data output size metric, a data write time metric, a latency metric, a data input pattern metric, a data output pattern metric, or any combination thereof.

4. The method of claim 2, wherein the partitioning sub-configuration comprises an indication of a partition, a tabular composition of the partition, an indication of a load distribution on the partition, one or more forecasted datasets associated with the partition, or any combination thereof.

5. The method of claim 1, further comprising:
applying an infrastructure recommendation machine learning model to one or more of the plurality of behavior parameters; and
generating an infrastructure sub-configuration for partitioning the data based at least in part on the applying, the infrastructure sub-configuration comprising one or more infrastructure parameters.

6. The method of claim 5, further comprising:
generating the infrastructure sub-configuration based at least in part on a data write time metric, a latency metric, a data input pattern metric, a data output pattern metric, an input operation timing metric, an output operation timing metric, a data size timing metric, a resource utilization history metric, a data storage environment size metric, a data storage environment growth rate metric, or any combination thereof.

7. The method of claim 5, wherein the infrastructure sub-configuration comprises an indication of an average resource usage level for the data replication process, a peak resource usage level for the data replication process, or any combination thereof.

8. The method of claim 1, further comprising:
applying a load pattern machine learning model to one or more of the plurality of behavior parameters; and
generating a load pattern sub-configuration for partitioning the data based at least in part on the applying, the load pattern sub-configuration comprising one or more load distribution parameters.

9. The method of claim 8, further comprising:
generating the load pattern sub-configuration based at least in part on an input operation timing metric, an output operation timing metric, a data size timing metric, a data storage environment size metric, a data storage environment growth rate metric, or any combination thereof.

10. The method of claim 8, wherein the load pattern sub-configuration comprises one or more time windows associated with one or more load levels of the source data storage environment, a forecasted schedule for the data replication process, or any combination thereof.

11. The method of claim 1, further comprising:
estimating an amount of time for performing the data replication process based at least in part on the one or more sub-configurations; and
generating one or more recommended time slots for the data replication process based at least in part on the estimating.

12. The method of claim 1, further comprising:
receiving one or more data replication parameters for performing the data replication process; and
performing the data replication process based at least in part on the one or more data replication parameters.

13. The method of claim 12, wherein the one or more data replication parameters comprise a preferred time slot, data replication performance metadata, an indication of a data partitioning scheme, or any combination thereof.

14. An apparatus for configuring a migration of data from a source data storage environment to a target data storage environment, comprising:
a processor;
memory coupled with the processor; and
instructions stored in the memory and executable by the processor to cause the apparatus to:
receive computing metadata associated with management of the data at the source data storage environment;
compute a plurality of behavior parameters for the source data storage environment based at least in part on the computing metadata;
determine one or more sub-configurations of a data migration plan based at least in part on an application of one or more machine learning models to the plurality of behavior parameters for the source data storage environment;
generate the data migration plan based at least in part on a combination of the one or more sub-configurations; and
perform a data replication process to replicate the data from the source data storage environment to the target data storage environment based at least in part on the data migration plan.

15. The apparatus of claim 14, wherein the instructions are further executable by the processor to cause the apparatus to:
apply a partition analyzer machine learning model to one or more of the plurality of behavior parameters; and
generate a partitioning sub-configuration for partitioning the data based at least in part on the applying, the partitioning sub-configuration comprising one or more partitioning parameters.

16. The apparatus of claim 14, wherein the instructions are further executable by the processor to cause the apparatus to:
apply an infrastructure recommendation machine learning model to one or more of the plurality of behavior parameters; and
generate an infrastructure sub-configuration for partitioning the data based at least in part on the applying, the infrastructure sub-configuration comprising one or more infrastructure parameters.

17. The apparatus of claim 14, wherein the instructions are further executable by the processor to cause the apparatus to:
apply a load pattern machine learning model to one or more of the plurality of behavior parameters; and
generate a load pattern sub-configuration for partitioning the data based at least in part on the applying, the load pattern sub-configuration comprising one or more load distribution parameters.

18. The apparatus of claim 14, wherein the instructions are further executable by the processor to cause the apparatus to:
estimate an amount of time for performing the data replication process based at least in part on the one or more sub-configurations; and
generate one or more recommended time slots for the data replication process based at least in part on the estimating.

19. The apparatus of claim 14, wherein the instructions are further executable by the processor to cause the apparatus to:
receive one or more data replication parameters for performing the data replication process; and
perform the data replication process based at least in part on the one or more data replication parameters.

20. A non-transitory computer-readable medium storing code for configuring a migration of data from a source data storage environment to a target data storage environment, the code comprising instructions executable by a processor to:
receive computing metadata associated with management of the data at the source data storage environment;
compute a plurality of behavior parameters for the source data storage environment based at least in part on the computing metadata;
determine one or more sub-configurations of a data migration plan based at least in part on an application of one or more machine learning models to the plurality of behavior parameters for the source data storage environment;
generate the data migration plan based at least in part on a combination of the one or more sub-configurations; and
perform a data replication process to replicate the data from the source data storage environment to the target data storage environment based at least in part on the data migration plan.
